(19) United States
(12) Patent Application Publication
(10) Pub. No.: US 2021/0096480 A1
(43) Pub. Date: Apr. 1, 2021

(54) IMAGE FORMATION APPARATUS AND IMAGE FORMATION METHOD

(71) Applicant: Oki Data Corporation, Tokyo (JP)

(72) Inventors: Yuji TAKINO, Tokyo (JP); Shin YAMADA, Tokyo (JP)

(73) Assignee: Oki Data Corporation, Tokyo (JP)

(21) Appl. No.: 17/019,351

(22) Filed: Sep. 14, 2020

(30) Foreign Application Priority Data
Sep. 30, 2019 (JP) 2019-178495

(51) Int. Cl. G03G 15/08; G03G 15/01

(52) U.S. Cl. CPC G03G 15/0848; G03G 15/0121

(57) ABSTRACT

An image formation apparatus according to an embodiment may include: a first image formation unit configured to develop a first image on a medium by using a sublimation printing developer; and a second formation unit configured to develop a second image by using a non-sublimation printing developer in an area outside an area of the first image on the medium.

### CROSS REFERENCE TO RELATED APPLICATIONS

This application claims priority based on 35 USC 119 from prior Japanese Patent Application No. 2019-178495 filed on Sep. 30, 2019, entitled “IMAGE FORMATION APPARATUS AND IMAGE FORMATION METHOD”, the entire contents of which are incorporated herein by reference.

### BACKGROUND

The disclosure may relate to an image formation apparatus and an image formation method to form an image by using a sublimation printing developer.

In a related art, an image is formed on a first medium by using a sublimation printing developer and then the image on the first medium is sublimated and transferred to a second medium such as cloth by an iron-on transfer.

Patent Document 1: Japanese Patent Application Publication No. 2019-28440.

### SUMMARY

However, a print quality of an image formed by a sublimation transfer method may not be sufficiently high, which still leaves a room for improvement in the quality of the image. An object of one or more embodiments of the disclosure may be to provide an image formation apparatus and an image formation method that are capable of suppressing sublimation transfer of a sublimation printing developer from a first medium to an unintended area on a second medium in a sublimation transfer printing.

An aspect of an embodiment of the disclosure may be an image formation apparatus that may include a first image formation unit and a second image formation unit. The first image formation unit is configured to develop a first image on a medium by using a sublimation printing developer. The second formation unit is configured to develop a second image by using a non-sublimation printing developer in an area outside an area where the first image is developed on the medium.

A second aspect of an embodiment of the disclosure may be an image formation method. The method may include: developing a first image on a medium by using a sublimation printing developer; and developing a second image by using a non-sublimation printing developer in an area outside an area where the first image is developed on the medium.

According to at least one of the image formation apparatus and the image formation method according to the above described aspects, it may be possible to suppress sublimation transfer of the sublimation printing developer from the medium to an unintended area on a second medium in a sublimation transfer printing.

### BRIEF DESCRIPTION OF DRAWINGS

FIG. 1 is a diagram illustrating a schematic view of a configuration example of an image formation apparatus according to an embodiment;

FIG. 2A is a diagram illustrating a plan view of a configuration example of a sublimation printing toner image and a non-sublimation printing toner image formed on a medium, and FIG. 2B is a diagram illustrating a cross sectional view of the configuration example taken along the A-A line in FIG. 2A;

FIG. 3 is a diagram illustrating a view of an example of an operation procedure of the image formation apparatus;

FIG. 4A is a diagram illustrating a view for explaining an iron-on transfer, and FIG. 4B is a diagram illustrating a view of an example of transferred image formed on a medium by the iron-on transfer;

FIGS. 5A and 5B are diagrams for explaining border bleeding;

FIGS. 6A and 6B are diagrams for explaining fogging (gray background);

FIG. 7 is a table illustrating experimental results regarding the border bleeding;

FIG. 8 is a diagram illustrating examples of transferred images obtained in the experiment regarding the border bleeding;

FIG. 9 is a table illustrating experimental results regarding the fogging;

FIG. 10 is a diagram illustrating an example of a relationship between an attached amount of a clear toner and a hue;

FIG. 11 is a diagram summarizing the experimental results illustrated in FIGS. 7 and 8;

FIG. 12A is a diagram illustrating a plan view of a configuration example of a sublimation printing toner image and a non-sublimation printing toner image formed on a medium according to a modification, and FIG. 12B is a diagram illustrating a cross sectional view of the configuration example taken along the A-A line in FIG. 12A; and

FIG. 13 is a diagram illustrating a schematic view of a configuration example of an image formation apparatus according to a modification.

### DETAILED DESCRIPTION

Hereinafter, one or more embodiments are described in detail with reference to the drawings. Note that the following description is directed to illustrative examples of the disclosure and not to be construed as limiting to the invention. The invention is not limited to the arrangements, dimensions, dimensional ratios, etc. of the elements illustrated in the drawings. The description is given in the following order.

1. Embodiments

2. Examples

3. Modifications

### 1. Embodiments

### [Configuration]

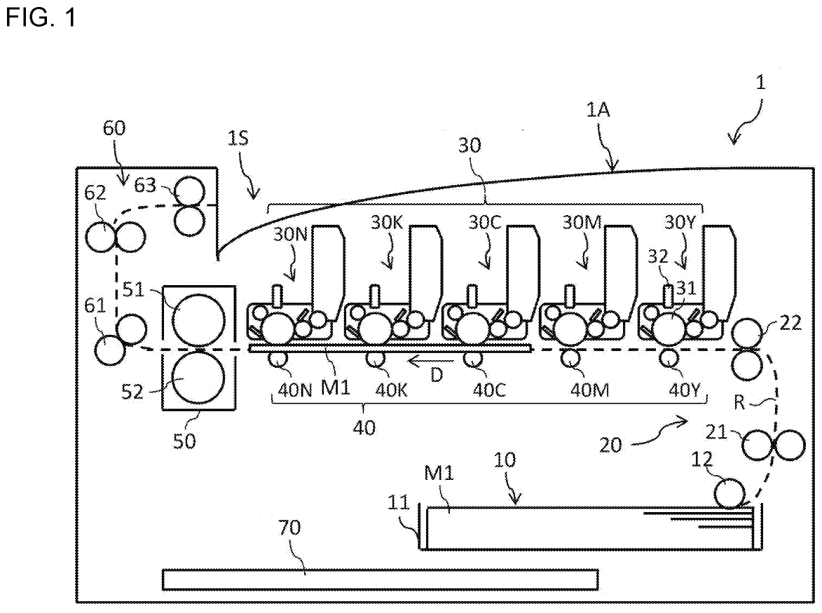

FIG. 1 is a diagram illustrating a schematic view of a configuration example of an image formation apparatus 1 according to an embodiment. The image formation apparatus 1 forms an image with the use of two types of toners, i.e., a sublimation printing toner (may be referred to as a textile-printing toner) and a non-sublimation printing toner (may be referred to as a non-textile-printing toner) on a medium M1. The image formation apparatus 1 may be a so-called electrophotographic full-color printer. More specifically, the image formation apparatus 1 is a direct transfer printer that forms an image directly on the medium M1 to be discharged to the outside of the image formation apparatus 1. The medium M1 is not particularly limited; however, the medium M1 may include, for example, any one type or two or more types of paper and film.

As illustrated in FIG. 1, the image formation apparatus 1 includes a medium feeding section 10 (or a medium feeder), a conveyance section 20, an image formation section 30, a transfer section 40 (or a transfer device), a fixation section 50 (or a fixation device), a discharge section 60 (or a discharge device), and a controller 70 in a housing 1A thereof, for example. The housing 1A is provided, for example, with a stacker 1S or an accumulation part in which the medium M1 having an image formed thereon is to be accumulated. The medium M1 is conveyed along a conveyance path R illustrated by a dashed line in the image formation apparatus 1.

The conveyance path R is a path through which the medium M1 is conveyed. A direction toward the medium feeding section 10 or a position closer to the medium feeding section 10 as seen from any component on the conveyance path R is referred to as upstream in the conveyance path R. A direction away from the medium feeding section 10 or a position farther from the medium feeding section 10 as seen from any component on the conveyance path R is referred to as downstream in the conveyance path R. The direction in which the medium M1 is conveyed in the conveyance path R (that is, the direction from the upstream side toward the downstream side in the conveyance path R) is referred to as a conveyance direction D.

### (Configuration of Medium Feeding Section 10)

The medium feeding section 10 feeds the media M1 one by one to the conveyance path R. The medium feeding section 10 includes a medium feeder tray 11 and a pick-up roller 12, for example. In the medium feeder tray 11, a plurality of the media M1 in a stacked state are housed. The medium feeder tray 11 is detachably attached to a lower portion of the image formation apparatus 1, for example. The pick-up roller 12 feeds the media M1 accommodated in the medium feeder tray 11 one by one to the conveyance section 20. The pick-up roller 12 is controlled by the controller 70 to rotate in a rotational direction to feed the medium M1 to the conveyance path R.

### (Configuration of Conveyance Section 20)

The conveyance section 20 conveys the medium M1 from the medium feeder section 10 toward the transfer section 40 along the conveyance path R. The conveyance section 20 is provided downstream of the medium feeder section 10 in the conveyance path R. The conveyance section 20 includes, for example, resist roller pairs 21 and 22.

The resist roller pair 21 is provided upstream of the resist roller pair 22 in the conveyance path R, and more specifically is provided between the medium feeder tray 11 and the resist roller pair 22. The resist roller pair 21 performs an abutting process on the medium M1 being conveyed in the conveyance path R and then conveys the medium M1 in the conveyance direction D along the conveyance path R. The abutting process means abutting a leading end of the medium M1 being conveyed from the medium feeding section 10 against the resist roller pair 21 whose rotation has been stopped. During the time when the abutting process is performed, the resist roller pair 21 does not receive a driving force of a motor controlled by the controller 70. That is, during the time when the abutting process is performed, the rotation of the resist roller pair 21 is stopped. When conveying the medium M1 by the resist roller pair 21, the resist roller pair 21 is controlled by the controller 70 and is thus rotated in a rotational direction to convey the medium M1 in the conveyance direction D.

The resist roller pair 22 is provided downstream of the resist roller pair 21 in the conveyance path R. The resist roller pair 22 conveys the medium M1 in the conveyance direction D along the conveyance path R. The pair 22 of the resist rollers are controlled by the controller 70 to be rotated in rotational directions to convey the medium M1 in the conveyance direction D.

### (Configuration of Image Formation Section 30)

The image formation section 30 is provided downstream of the conveyance section 20 in the conveyance path 20. The image formation section 30 performs a development process with toners. Specifically, the image formation section 30 forms an electrostatic latent image(s) and attaches toner(s) to the electrostatic latent image(s) by utilizing Coulomb force.

The image formation section 30 includes, for example, five development parts 30Y, 30M, 30C, 30K, and 30N (or development devices) that perform development processes. The development parts 30Y, 30M, 30C, 30K, and 30N have configurations same as or similar to each other, except for being mounted with toners different in type (or color) from each other, for example. Each of the development parts 30Y, 30M, 30C, 30K, and 30N includes a photosensitive drum 31 on which an electrostatic latent image is to be formed, and a light source 32 or an exposure device that forms the electrostatic latent image on the surface of the photosensitive drum 31, for example. Each of the development parts 30Y, 30M, 30C, 30K, and 30N further includes devices such as a charging roller, a developing roller, or a feeding roller, for example.

The photosensitive drum 31 is a cylindrical member having a peripheral surface including a photoconductor (for example, an organic photoconductor) and capable of carrying an electrostatic latent image on the peripheral surface. Specifically, the photosensitive drum 31 has a conductive support and a photoconductive layer covering the outer periphery (surface) of the conductive support. The conductive support is configured as a metal pipe made of aluminum, for example. The photoconductive layer is, for example, a multi-layered structure including a charge generation layer and a charge transport layer stacked in order. The photosensitive drum 31 is controlled by the controller 70 to be rotated in a rotational direction at a predetermined circumferential speed to convey the medium M1 in the conveyance direction D.

The light source 32 is an exposure device that forms an electrostatic latent image on the charged circumferential surface of the photosensitive drum 31 by emitting light onto the circumferential surface of the photosensitive drum 31. The light source 32 includes a plurality of light emitting parts arranged in a widthwise direction of the photosensitive drum 31. Each of the light emitting parts includes, for example, light emitting elements such as light emitting diodes (LED) that irradiate lights and a lens array that forms an image of the irradiation lights on the surface of the photosensitive drum 31.

The development parts 30Y, 30M, 30C, 30K, and 30N are disposed, for example, in this order from upstream toward downstream in the conveyance direction D of the medium M1. In other words, the development parts 30N is disposed downstream of the development parts 30Y, 30M, 30C, and 30K in the conveyance direction D of the medium M1 by the conveyance section 20. A development unit composed of the development parts 30Y, 30M, 30C, and 30K may be an example of a “first image formation unit” in the disclosure. A development unit composed of the development part 30N may be an example of a “second image formation unit” in the disclosure.

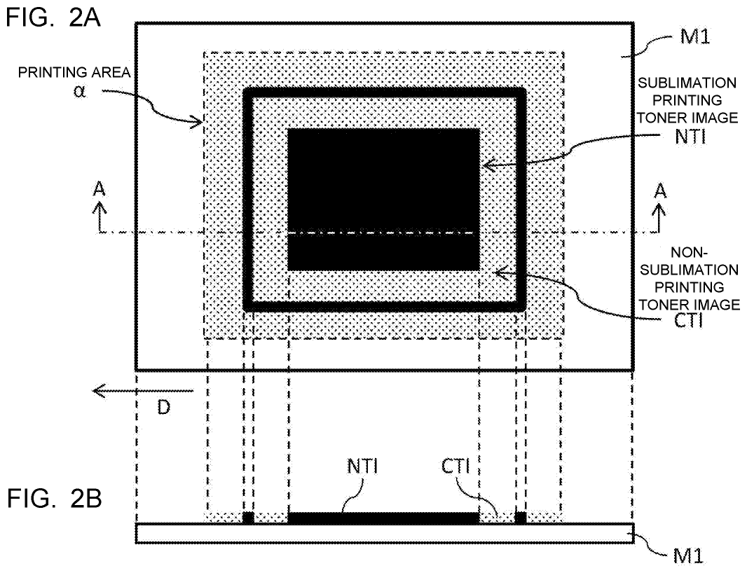

The development part 30Y forms a sublimation printing toner image by using a yellow sublimation printing toner, for example. The development part 30M forms a sublimation printing toner image by using a magenta sublimation printing toner, for example. The development part 30C forms a sublimation printing toner image by using a cyan sublimation printing toner, for example. The development part 30K forms a sublimation printing toner image by using a black sublimation printing toner, for example. Each of the development parts 30Y, 30M, 30C, and 30K uses a sublimation printing toner (yellow sublimation printing toner, sublimation magenta toner, cyan sublimation printing toner, and black sublimation printing toner) to form a sublimation printing toner image. The sublimation printing toner image is formed of the sublimation printing toner (the yellow sublimation printing toner, the magenta sublimation printing toner, the cyan sublimation printing toner, or the black sublimation toner). The development unit composed of the development parts 30Y, 30M, 30C, and 30K transfers the sublimation printing toner images formed by the development parts 30Y, 30M, 30C, and 30K onto the medium M1, and thereby forming a sublimation printing toner image NTI (first image) on the medium M1 (for example, see FIG. 2). The development unit composed of the development parts 30Y, 30M, 30C, and 30K forms the sublimation printing toner image NTI (first image) corresponding to image data input from the external device or the like, for example. Here, the image data may be image data that is input from the outside of the image formation apparatus 1 to the controller 70. The development unit composed of the development parts 30Y, 30M, 30C, and 30K receives a print control signal(s) corresponding to the image data input from the controller 70, and thus forms the sublimation printing toner image (image) corresponding to the image data input from the outside.

In contrast, the development part 30N forms a non-sublimation toner image with the use of the non-sublimation toner. The non-sublimation printing toner image is formed of the non-sublimation printing toner. The development part 30N transfers the non-sublimation printing toner formed by the development part 30N onto the medium M1, and thereby forming a non-sublimation printing toner image CTI (second image) on the medium M1 in an area outside the area of the first image. The development part 30N forms the non-sublimation toner image CTI (second image) corresponding to the entire or a part of a background included in the image corresponding to the image data input from the outside, for example.

The yellow sublimation printing toner, the magenta sublimation printing toner, the cyan sublimation printing toner, and the black sublimation printing toner are toners used for forming a full-color image, and in particular, are color toners which are transferable to a medium M2 by utilizing the sublimation printing transferability when heated. The medium M2 is a medium different from the medium M1 on which an image is to be formed by the image forming apparatus 1. The medium M2 may be a fabric or the like, for example. The non-sublimation printing toner is a toner used to improve quality of an image transferred on the medium M2, when the image is transferred from the medium M1 onto the medium M2.

The sublimation printing toner is a toner that includes a sublimation printing developer (or sublimation printing visualization agent). The sublimation printing developer included in the sublimation printing toner is a colorant whose sublimability is higher than that of the non-sublimation printing toner. In the disclosure, the description of “forming a sublimation printing toner image” may be read as “visualizing a sublimation printing toner image” or “developing a sublimation printing toner image.” To the contrary, the non-sublimation printing toner is toner (non-sublimation printing developer) that does not include a sublimation printing developer and made of materials whose sublimability is relatively lower than the colorant included in the sublimation printing toner. The non-sublimation printing toner may be a clear toner (transparent toner), for example. In the disclosure, the description of “forming a non-sublimation printing toner image” may be read as “visualizing a non-sublimation printing toner image” or “developing a non-sublimation printing toner image.” A detailed configuration of each of the non-sublimation printing toner and the sublimation printing toners (the yellow sublimation printing toner, the magenta sublimation printing toner, the cyan sublimation printing toner, and the black sublimation printing toner) is described later.

### [Configuration of Transfer Section 40]

The transfer section 40 performs the transfer process using the toner developed by the image formation section 30. Specifically, the transfer section 40 transfers the toner attached to the electrostatic latent image on the photosensitive drum 31 onto the medium M1 being conveyed from the conveyance section 20.

The transfer section 40 includes five transfer rollers, i.e., transfer rollers 40Y, 40M, 40C, 40K, and 40N, for example. The transfer rollers 40Y, 40M, 40C, 40K, and 40N transfer (directly transfer) the toners attached to the electrostatic latent images to the medium M1. The transfer roller 40Y is in pressure contact with the photosensitive drum 31 of the development part 30Y. The transfer roller 40M is in pressure contact with the photosensitive drum 31 of the development part 30M. The transfer roller 40C is in pressure contact with the photosensitive drum 31 of the development part 30C. The transfer roller 40K is in pressure contact with the photosensitive drum 31 of the development part 30K. The transfer roller 40N is in pressure contact with the photosensitive drum 31 of the development part 30N. The transfer rollers 40Y, 40M, 40C, 40K, and 40N are controlled by the controller 70 to be rotated in rotational directions to convey the medium M1 in the conveyance direction D.

### (Configuration of Fixation Section 50)

The fixation section 50 performs a fixing process using the toners transferred to the medium M1 by the transfer section 40. Specifically, the fixation section 50 fixes the toners onto the medium M1 by heating and pressing the medium M1 on which the toners are transferred by the transfer section 40. The fixation section 50 is configured to include an upper roller 51 and a lower roller 52, for example.

Each of the upper roller 51 and the lower roller 52 includes therein a heat source serving as a heater such as a halogen lamp or the like, for example, and thus functions as a heating roller that applies heat to the toners on the medium M1. The upper roller 51 is controlled by the controller 70 and thus is rotated in a rotational direction to convey the medium M1 in the conveyance direction D. The heat sources in the upper roller 51 and the lower roller 52 receive bias voltages controlled by the controller 70 and thus controls the surface temperatures of the upper roller 51 and the lower roller 52. The lower roller 52 is opposed to the upper roller 51 forming a nip portion (pressure contact part) between the upper roller 51 and the lower roller 52, and thus functions as a pressure roller that applies pressure to the toner on the medium M1. It may be preferable that the lower roller 52 includes a surface layer made of an elastic material.

### (Configuration of Discharge Section 60)

The discharge section 60 discharges, to the outside of the image formation apparatus 1, the medium M1 on which the toners are fixed by the fixation section 50. The discharge section 60 includes, for example, conveyance roller pairs 61, 62, and 63. The conveyance roller pairs 61, 62, and 63 discharge the medium M1 through the conveyance path R to the outside of the image formation apparatus 1 so as to accumulate the media M1 on an accumulation part 1S or a stacker outside the image formation apparatus 1. The conveyance roller pairs 61, 62, and 63 are controlled by the controller 70 to be rotated in rotational directions to convey the medium M1 in the conveyance direction D. The conveyance roller pairs 61, 62, and 63 discharge, to the accumulation part 1S, the medium M1 with its printed surface faces downward.

### (Configuration of Controller 70)

The controller 70 controls the overall operation of the image forming apparatus 1. The controller 70 may be a circuit board provided with a control circuit, a memory, an input-output port, a timer, and the like. The control circuit may include, for example, a central processing unit (CPU) or the like.

The controller 70 outputs, to the development unit composed of the development parts 30Y, 30M, 30C, and 30K, a print control signal to form the sublimation printing toner image NTI (first image) corresponding to the image data (first image data) input from the outside, for example. The controller 70 further outputs, to the development part 30N, a print control signal to form the non-sublimation toner image CTI (second image) corresponding to the entire or a part of the background included in the image corresponding to the image data (first image data) input from the outside, for example.

### (Configurations of Sublimation Printing Toner Image NTI and Non-Sublimation Toner Image CTI)

FIGS. 2A and 2B illustrate an example of the sublimation printing toner image NTI and the non-sublimation printing toner image CTI formed on the medium M1. FIG. 2A is a diagram illustrating a plan view of a configuration example of the sublimation printing toner image NTI and the non-sublimation printing toner image CTI formed on the medium M1. FIG. 2B is a diagram illustrating a cross sectional view of the configuration example taken along the A-A line in FIG. 2A.

The sublimation printing toner image NTI is formed on the medium M1 and specifically in a printing area α on the medium M1. The non-sublimation printing toner image CTI is formed in the printing area a on the medium M1 and specifically at an area outside of the area of the sublimation printing toner image NTI in the printing area α on the medium M1. The non-sublimation printing toner image CTI is formed adjacent to the sublimation printing toner image NTI, for example. In this case, the non-sublimation printing toner image CTI is formed being in contact with the entire of the peripheral edge of the sublimation printing toner image NTI and surrounding the sublimation printing toner image NTI as seen in the plan view, for example. The non-sublimation printing toner image CTI may be formed over the entire of the area outside the area of the sublimation printing toner image NTI in the printing area a on the medium M1, for example. In this case, the development part 30N forms the non-sublimation printing toner image CTI in the entire of the area outside the area of the sublimation printing toner image NTI in the printing area α on the medium M1, for example. The non-sublimation printing toner image CTI may be formed in a part of the area outside the area of the sublimation printing toner image NTI in the printing area a on the medium M1, for example. In this case, the development part 30N forms the non-sublimation printing toner image CTI in a part of the area outside the area of the sublimation printing toner image NTI in the printing area α on the medium M1, for example. In an embodiment, the development part 30N forms the non-sublimation printing toner image CTI on the medium M1 with an attached amount (formed amount) of the non-sublimation printing toner on the medium M1 being equal to or greater than 0.01 mg/cm², for example. In an embodiment, the development part 30N forms the non-sublimation printing toner image CTI on the medium M1 with an attached amount (formed amount) of the non-sublimation printing toner on the medium M1 being equal to or greater than 0.04 mg/cm², for example. In an embodiment, the development part 30N forms the non-sublimation printing toner image CTI on the medium M1 with an attached amount (formed amount) of the non-sublimation printing toner on the medium M1 being equal to or greater than 0.18 mg/cm², for example. In an embodiment, the development part 30N forms the non-sublimation printing toner image CTI on the medium M1 with an attached amount (formed amount) of the non-sublimation printing toner on the medium M1 being equal to or less than 0.77 mg/cm², for example. In an embodiment, the development part 30N forms the non-sublimation printing toner image CTI on the medium M1 with an attached amount (formed amount) of the non-sublimation printing toner on the medium M1 being equal to or less than 0.54 mg/cm², for example.

### (Configuration of Toner)

The toner described below may be a negatively-charged toner for a single component development, for example. In other words, the toner may have a negatively-charged polarity, for example. The single component development provides the toner itself with an appropriate amount of electric charge and thereby applies an electric charge to the toner without using a carrier, e.g., a magnetic particle. In contrast, a two-component development provides a mixture of the foregoing carrier and the toner and thereby applies an appropriate amount of electric charge to the toner by utilizing friction between the carrier and the toner.

A method of manufacturing the toner is not particularly limited. Specifically, the method of manufacturing the toner may include pulverization, polymerization, or a method other than those. Two or more of the foregoing methods may be used in any combination. The polymerization may include an emulsion polymerization aggregation method and a solution suspension method, for example.

### [Configuration of Non-Sublimation Printing Toner]

The non-sublimation printing toner is a toner (a dyeable toner) having a property of being dyed by the sublimation printing developer (colorant) contained in the sublimation printing toner. That is, as will be described later, the non-sublimation printing toner is a receptor that receives the sublimation printing developer transferred from the sublimation printing toner by using heat energy when the heat energy is supplied to the sublimation printing toner. When the non-sublimation printing toner receives the sublimation printing developer, the non-sublimation printing toner is dyed by the sublimation printing developer.

The non-sublimation printing toner is a dyeable developer containing polymer compound that can be dyed with the sublimation printing developer (the colorant) contained in the sublimation printing toner. The non-sublimation printing toner contains, for example, one type or two or more types of polymer compounds. This polymer compound is a polymer compound having the property of being dyed with the sublimation printing developer. Specifically, the polymer compound is, for example, a polyester-based resin, a styrene-acrylic-based resin, an epoxy-based resin, a styrene-butadiene-based resin, or the like.

The polyester-based resin is a general term including polyester and its derivatives. That is, “based” of “polyester-based resin” means that not only polyester but also derivatives are included. The definition of “based” is the same for styrene-acrylic-based resins, epoxy-based resins, styrene-butadiene-based resins, and the like.

Above all, the polymer compound preferably contains a polyester-based resin. Firstly, the non-sublimation printing toner containing the polyester-based resin is easily dyed with the sublimation printing developer. Secondly, since the polyester-based resin has a high affinity for the medium M1 such as a paper sheet, the non-sublimation printing toner containing the polyester-based resin is easily fixed to the medium M1. Thirdly, since the polyester-based resin has high physical strength even when the molecular weight is relatively small, the non-sublimation printing toner containing the polyester-based resin has excellent durability. Fourthly, even if the non-sublimation printing toner has low charging characteristics in nature, the non-sublimation printing toner is easily fixed to the medium M1.

The crystalline state of the polyester-based resin is not particularly limited. Therefore, the polyester-based resin may be a crystalline polyester, an amorphous polyester, or both. Of these, crystalline polyester is preferable. This is because the non-sublimation printing toner is easily dyed with the sublimation printing developer. Further, the non-sublimation printing toner is more easily fixed on the medium M1, and the durability of the non-sublimation printing toner is further improved.

This polyester-based resin is, for example, a reaction product (condensation polymer) of one type or two or more types of alcohol and one type or two or more types of carboxylic acid.

The type of alcohol is not particularly limited, but divalent or higher alcohols and derivatives thereof are preferable. Examples of the divalent or higher alcohol include ethylene glycol, diethylene glycol, triethylene glycol, polyethylene glycol, propylene glycol, butanediol, pentanediol, hexanediol, cyclohexanedimethanol, xylene glycol, dipropylene glycol, polypropylene glycol, bisphenol A, hydrogenated bisphenol A, bisphenol A ethylene oxide, bisphenol A propylene oxide, sorbitol, glycerin, and the like.

The type of carboxylic acid is not particularly limited, but among them, divalent or higher carboxylic acids and derivatives thereof are preferable. Examples of the divalent or higher carboxylic acid include maleic acid, fumaric acid, phthalic acid, isophthalic acid, terephthalic acid, succinic acid, adipic acid, trimellitic acid, pyromellitic acid, cyclopentanedicarboxylic acid, succinic anhydride, trimellitic anhydride, maleic anhydride, dodecenyl succinic anhydride, and the like.

Note that the color of the sublimation printing toner is not particularly limited. Therefore, the sublimation printing toner may contain a colorant as in the sublimation printing toner, or may not contain a colorant, unlike the sublimation printing toner. The colorant included in the non-sublimation printing toner has no dying property unlike the colorant (the sublimation printing developer) included in the sublimation printing toner.

In the case where the non-sublimation printing toner does not contain a colorant, the non-sublimation printing toner is colorless (transparent). The colorless non-sublimation printing toner is, for example, a so-called clear toner. In this case, the non-sublimation printing toner image CTI may be colorless, which makes a hue of the non-sublimation printing toner image CTI hardly influence a hue of the sublimation printing toner image NTI.

In the case where the non-sublimation printing toner contains a colorant having no dyeing property, the color of the non-sublimation printing toner is not particularly limited. Therefore, the color of the non-sublimation printing toner may be yellow, magenta, cyan, black, white, or a mixture of two or more of them. In this case, the non-sublimation printing toner includes, for example, a colorant having a color corresponding to the color of the non-sublimation printing toner, and the colorant includes, for example, one type or two or more types of pigments and/or dyes. For example, a white non-sublimation printing toner may include a pigment such as titanium oxide.

It may be preferable that the non-sublimation printing toner has such a color that the hue of the non-sublimation printing toner image CTI has less influence on the hue of the sublimation printing toner image NTI. Therefore, it may be preferable that the color of the non-sublimation printing toner is white. However, the color of the non-sublimation printing toner image CTI is not limited to white and may be a light color such as a light gray as long as the hue of the non-sublimation printing toner image CTI does not easily affect the hue of the sublimation printing toner image NTI.

Here, it may be preferable that the non-sublimation printing toner has such a color that the hue of the non-sublimation printing toner image TN has less influence on the hue of the sublimation printing toner image TD, as described above. Therefore, the color of the non-sublimation printing toner is more preferably colorless (transparent) or white, and even more preferably colorless (transparent). That is, since the non-sublimation printing toner does not contain a colorant, the color of the non-sublimation printing toner is particularly preferably colorless.

However, the non-sublimation printing toner may further include one type or two or more types of other materials such as an additive. The type of other materials is not particularly limited, and examples thereof include external additives, release agents, charge control agents, conductivity adjusters, reinforcing fillers, antioxidants, antioxidants, fluidity improvers, and cleaning properties.

The external additive mainly suppresses phenomenon such as aggregation in the toner, and thereby improves fluidity of the toner. The external additive includes one type or two or more types of materials such as an inorganic material or an organic material, for example. The inorganic material may be, for example, hydrophobic silica, or the like. The organic material may be, for example, melamine resin, or the like.

The content of the external additive is not particularly limited. In an embodiment, the content of the external additive is, for example, 0.01 parts by weight to 10 parts by weight, preferably 0.05 parts by weight to 8 parts by weight, relative to 100 parts by weight of the polymer compound.

A release agent mainly improves the fixing property and offset resistance of the toner. The release agent includes, for example, one type or two or more types of waxes such as aliphatic hydrocarbon wax, oxide of aliphatic hydrocarbon wax, fatty acid ester wax, and deoxidation of fatty acid ester wax. In addition, the release agent may be, for example, a block copolymer of the series of waxes described above.

The aliphatic hydrocarbon wax is, for example, low molecular weight polyethylene, low molecular weight polypropylene, olefin copolymer, microcrystalline wax, paraffin wax, Fischer-Tropsch wax and the like. The oxide of the aliphatic hydrocarbon wax is, for example, oxidized polyethylene wax. Examples of the fatty acid ester wax include carnauba wax, montanic acid ester wax, and the like. The deoxidation of fatty acid ester wax is a wax obtained by partially or entirely deoxidizing the fatty acid ester wax, and is, for example, deoxidized carnauba wax.

The content of the release agent is not particularly limited, but is, for example, 0.1 parts by weight to 20 parts by weight, preferably 0.5 parts by weight to 12 parts by weight, relative to 100 parts by weight of the polymer compound.

A charge control agent mainly controls the triboelectric chargeability of the toner. The charge control agent used for the negatively charged toner contains, for example, any one type or two or more types of an azo complex, a salicylic acid complex, a calixarene complex, and the like.

The content of the charge control agent is not particularly limited, but is, for example, 0.05 parts by weight to 15 parts by weight with respect to 100 parts by weight of the polymer compound.

### (Configuration of Sublimation Printing Toner)

The yellow sublimation printing toner, magenta sublimation printing toner, cyan sublimation printing toner and black sublimation printing toner include the sublimation printing developers of the corresponding colors, respectively. The sublimation printing developers are sublimation printing yellow dyes, sublimation printing magenta dyes, sublimation printing cyan dyes, and sublimation printing black dyes.

Specifically, the yellow sublimation printing toner has a configuration same as or similar to the non-sublimation printing toner except that the yellow sublimation printing toner contains one type or two or more types of sublimation printing yellow dyes as a colorant, and one type or two or more types of binders instead of the polymer compound, for example. The sublimation printing yellow dye is, for example, C. L Reactive Yellow 2, C. L Disperse Yellow 54, Disperse Yellow 160, C. L Yellow 114, or the like. The binder is, for example, polyester-based resin, styrene-acrylic-based resin, epoxy-based resin, styrene-butadiene-based resin, or the like.

However, the yellow sublimation printing toner may include no release agent unlike the non-sublimation printing toner. In this case, mainly due to the presence or absence of the release agent, the sublimation printing toner and the non-sublimation printing toner have different thermal physical properties (endothermic properties). The difference in the endothermic properties (heat absorption properties) is described later.

The content of the sublimation printing yellow dye is not particularly limited, but may be, for example, 2 parts by weight to 25 parts by weight, preferably 2 parts by weight to 15 parts by weight, based on 100 parts by weight of the binder. The content of the release agent is not particularly limited, but may be, for example, 0.1 parts by weight to 20 parts by weight, preferably 0.5 parts by weight to 12 parts by weight, relative to 100 parts by weight of the binder. The content of the charge control agent is not particularly limited, but may be, for example, 0.05 to 15 parts by weight with respect to 100 parts by weight of the binder. The content of the external additive is not particularly limited, but may be, for example, 0.01 parts by weight to 10 parts by weight, preferably 0.05 parts by weight to 8 parts by weight, relative to 100 parts by weight of the binder.

The magenta sublimation printing toner has a configuration same as or similar to that of the yellow sublimation printing toner except that the magenta sublimation printing toner contains a sublimation printing magenta dye instead of the sublimation printing yellow dye. The sublimation printing magenta dye is, for example, C. L Reactive Red 3, C. L Disperse Red 50, C. L Disperse Red 92, and/or the like. The content of the sublimation printing magenta dye is the same as the content of the sublimation printing yellow dye, for example.

The cyan sublimation printing toner has a configuration same as or similar to that of the yellow sublimation printing toner, except that the cyan sublimation printing toner contains a sublimation printing cyan dye instead of the sublimation printing yellow dye, for example. The sublimation printing cyan dye is, for example, C. L Disperse Blue 60, C. L Reactive Blue 15, C. L Disperse Blue 359, C. L Solvent Blue 63, C. L Disperse Blue 165, Cibacron Turquoise Blue FGF-P, and/or the like. The content of the sublimation printing cyan dye is the same as the content of the sublimation printing yellow dye, for example.

The black sublimation printing toner has a configuration same as or similar to that of the yellow sublimation printing toner except that the black sublimation printing toner contains a sublimation printing black dye instead of the sublimation printing yellow dye, for example. The black sublimation dye is, for example, C. L Reactive Black 5, and/or the like. Note that the sublimation printing black dye may be, for example, a mixture of a sublimation printing yellow dye, a sublimation printing magenta dye, and a sublimation printing cyan dye. The content of the sublimation printing black dye is the same as the content of the sublimation printing yellow dye, for example.

### [Operation]

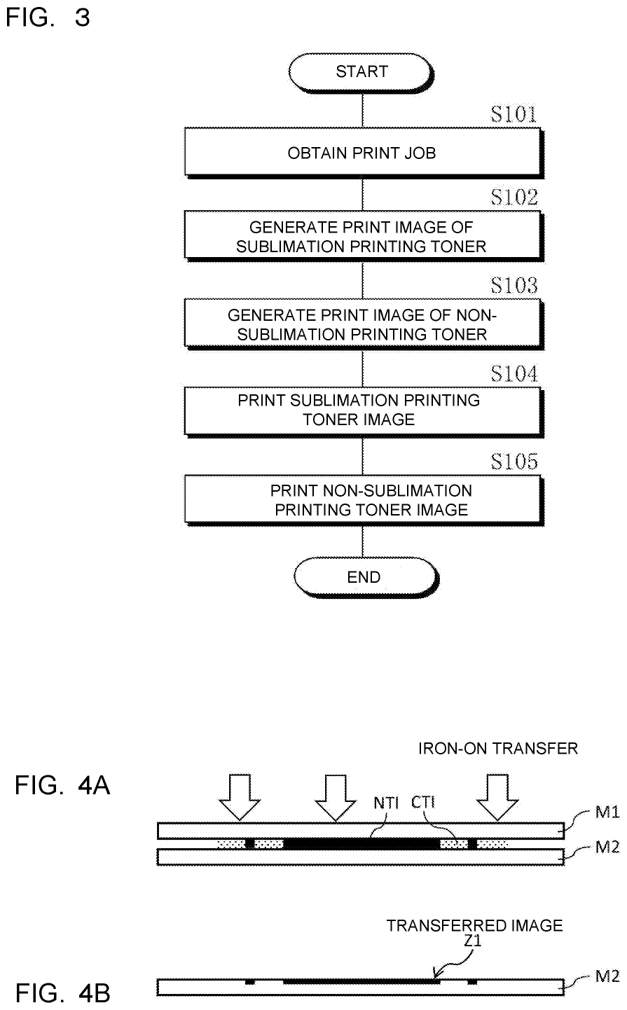

Next, an outline of operation of the image formation apparatus 1 is described with reference to FIG. 3. FIG. 3 illustrates an example of an operation procedure of the image formation apparatus 1. The image formation apparatus 1 forms a toner image on the medium M1 in the following manner, for example. The image formation apparatus 1 obtains a print job from an image transmitting apparatus through a communication line (Step S101). In response to this, the image formation apparatus 1 executes the print processing on the medium M1 by performing the following operations.

First, the controller 70 generates, based on image data included in the print job, a print image of the sublimation printing toner and a print image of the non-sublimation printing toner (Steps S102, S103). The controller 70 generates, based on the print image of the sublimation printing toner, the print control signal to form the sublimation printing image NTI (first image) and generates, based on the print image of the non-sublimation printing toner, the print control signal to form the non-sublimation printing image CTI (second image).

Next, the controller 70 inputs the print control signals to the development parts 30Y, 30M, 30C, 30K, and 30N. In response to this, the development parts 30Y, 30M, 30C, 30K, and 30N rotate the photosensitive drums 31 thereof and uniformly charge the circumferential surfaces of the photosensitive drums 31 by the charging rollers thereof which apply DC (direct current) voltages to the circumferential surfaces of the photosensitive drums 31. Next, the development parts 30Y, 30M, 30C, 30K, and 30N emit lights, based on the print control signal input from the controller 70, to the surfaces of the photosensitive drums 31 from the light sources 32, to attenuate the surface potentials of the light-irradiated areas of the surfaces of the photosensitive drums 31, so as to form electrostatic latent images.

When the temperatures of the upper roller 51 and the lower roller 52 reach the predetermined temperature, the medium feeding section 10 picks up (separates) the media M1 in the medium feeder tray 11 one by one from the uppermost end of the media M1, and feeds the separated medium M1 to the conveyance path R by the pick-up roller 12. Next, the conveyance section 20 corrects the skew of the medium M1 by the abutting process of the resist roller pair 21 and then conveys the medium M1 to the resist roller pair 22. Then, the conveyance section 20 conveys the medium M1 in the conveyance direction D along the conveyance path R by the resist roller pair 22.

Then, the development parts 30Y, 30M, 30C, and 30K supply and attach the sublimation printing toners to the electrostatic latent images on the surfaces of the photosensitive drums 31, and then transfer, by the transfer rollers 40Y, 40M, 40C, and 40K, the sublimation printing toners attached to the surfaces (the electrostatic latent images) on the photosensitive drums 31 to the medium M1 being conveyed in the conveyance direction D, so as to form the sublimation printing toner image NTI on the medium M1. That is, the development parts 30Y, 30M, 30C, and 30K form (visualize, develop) the sublimation printing toner image NTI on the medium M1 by using the sublimation printing toners (sublimation printing developers). To the contrary, the development part 30N supplies and attaches the non-sublimation printing toner to the electrostatic latent image on the surface of the photosensitive drum 31, and then transfers, by the transfer roller 40N, the non-sublimation printing toner attached to the surface (the electrostatic latent image) on the photosensitive drum 31 to the medium M1 being conveyed in the conveyance direction D, so as to form the sublimation printing toner image CTI in the area outside the area of the sublimation printing toner image on the medium M1. That is, the development part 30N forms (visualizes, develops) the non-sublimation printing toner image CTI on the medium M1 in the area outside the area where the sublimation printing toner image NTI is formed (visualized, developed), by using the non-sublimation printing toner (non-sublimation printing developer). In this way, the print processing on the medium M1 is executed.

Next, with reference to FIGS. 4A and 4B, an iron-on transfer by using the medium M1 that has the sublimation printing toner image NTI and the non-sublimation printing toner image CTI formed thereon is described below. FIG. 4A is a diagram illustrating a view for explaining an iron-on transfer. FIG. 4B illustrates an example of a transferred image formed on the medium M2 by the iron-on transfer.

As illustrated in FIG. 4A, the medium M1 that has the sublimation printing toner image NTI and the non-sublimation printing toner image CTI formed thereon is disposed so as to be opposed to the medium M2 as a transfer target. At this time, the medium M1 is disposed such that the sublimation printing toner image NTI and the non-sublimation printing toner image CTI are opposed to the medium M2. Thereafter, the medium M1 is closely attached to the medium M2, and then an iron (ironing tool) is pressed on the medium M1 to supply thermal energy H to the medium M1. Note that conditions regarding a temperature of the iron, a time period during which the iron is pressed against the medium M2, and a weight applied to the medium M1 with the iron, and the like may be set to any conditions. Accordingly, the sublimation printing developer is transferred from the sublimation printing toner image NTI on the medium M1 to the medium M2 by using the thermal energy H. As a result, an image (transferred image Z1) corresponding to the sublimation printing toner image NTI is formed on the medium M2. In this way, the iron-on transfer is executed.

### [Effects]

Next, effects of the image formation apparatus 1 are described.

In a related art, an image is formed on a first medium by using a sublimation printing developer and then the image on the first medium is sublimated and transferred to a second medium such as cloth by an iron-on transfer. For example, by such a sublimation transfer method, an image is printed on fabric such as a T-shirt or the like. However, when using the sublimation transfer method, “border bleeding” or “fogging” may occur and thus the print quality of the image may be likely to be deteriorated. For example, in the case where an image is printed on fabric of a cloth such as a T-shirt by the sublimation transfer method, the commercial value of the cloth such as a T-shirt may decrease if the print image quality is low. Accordingly, “border bleeding” and “fogging” are described first and then the effects of the image formation apparatus 1 is described.

### (Border Bleeding)

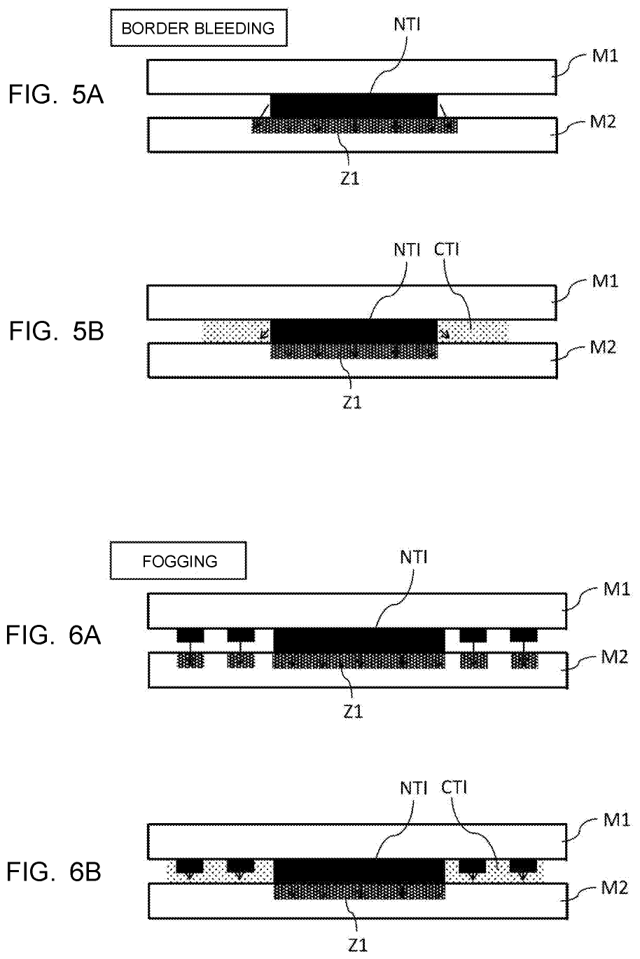

FIG. 5A illustrates a state where “border bleeding” occurs in the iron-on transfer. FIG. 5B illustrates a mechanism that suppresses the occurrence of the “border bleeding” in the iron-on transfer. As illustrated in FIG. 5A, in the iron-on transfer, the sublimation printing developer contained in the sublimation printing toner image NTI is transferred not only to an area on the medium M2 opposed to the sublimation printing toner image NTI but also to an area on the medium M2 around the area opposed to the sublimation printing toner image NTI. Thus, the boundary of the transferred image Z1 does not have a sharpness like the sharpness of the boundary of the sublimation printing toner image NTI and is blurred. In this way, when the border bleeding (the blurring at the boundary) of the transferred image Z1 occurs, the print quality of the transferred image Z1 is deteriorated. On the other hand, in the case where the non-sublimation printing toner image CTI is formed in the area outside the area of the sublimation printing toner image NTI on the medium M1 as illustrated in FIG. 5A, the sublimation printing developer sublimated from in the peripheral edge of the sublimation printing toner image NTI is caught by the non-sublimation printing toner image CTI and thus dyes the non-sublimation printing toner image CTI. As a result, the “border bleeding” of the transferred image Z1 can be suppressed. Accordingly, when the sublimation transfer is executed by using the medium M1 on which the sublimation printing toner image NTI and the non-sublimation printing toner image CTI are printed by the image formation apparatus 1, it is possible to manufacture clothes such as T-shirts or the like in which “border bleeding” is suppressed and which thus have a high image quality.

It is noted that in the case where the non-sublimation printing toner image CTI is in contact with the edge of the sublimation printing toner image NTI, the non-sublimation printing toner image CTI not only catches the sublimation printing developer sublimated from the edge of the sublimation printing toner image NTI but also suppresses the deformation of the edge of the sublimation printing toner image NTI. As a result, the “border bleeding” of the transferred image Z1 can be further suppressed. Therefore, it is possible to manufacture a cloth such as a T-shirt or the like having a further high image quality.

### (Fogging)

FIG. 6A illustrates a state where the iron-on transfer is executed by using the medium M1 having “fogging” thereon. FIG. 6B illustrates how the “fogging” on medium M1 is prevented from being transferred to the medium M2 in the iron-on transfer process. When the image formation apparatus 1 is left for a long time, the toner is not sufficiently charged in first few prints. As a result, a phenomenon called “fogging” occurs in which unnecessary toner (sublimation printing toner) attached to the photosensitive drum 31 is transferred to the medium M1.

The “fogging” refers to a phenomenon in which a density of a non-image portion, which should be a white spot (no image), becomes high due to the toner adhered to a background portion around the image portion. Hereinafter, a toner having a low charge amount that causes “fogging” or a toner charged with an opposite polarity that causes “fogging” may be referred to as “fogging toner”. In an embodiment, when the toner is normally charged, the toner has the negative polarity, and thus the toner having the positive polarity become the fogging toner.

FIGS. 6A and 6B illustrate examples where the medium M1 having the “fogging” thereon is used for the iron-on transfer. As illustrated in FIG. 6A, the sublimation printing developer contained in the unnecessary toner on the medium M1, which is transferred to the medium M1 by the “fogging”, is transferred to the medium M2, in the iron-on transfer process.

The “fogging” is inconspicuous on the medium M1. This is because the unnecessary toner enters in minute irregularities on the medium M1, and good results can be obtained by a visual judgment, a fogging measurement device, and the like. However, after the sublimation printing toner on the medium M1 is thermally transferred to the medium M2, the “fogging” may be conspicuous on the medium M2. This is because when thermal transfer is performed, the sublimation printing developer contained in the sublimation printing toner in the irregularities on the medium M1 are sublimed to dye the surface of the medium M2. Accordingly, the inconspicuous sublimation printing toner on the medium M1 become conspicuous on the medium M2. Therefore, when there is the “fogging” on the medium M1, the print quality of the transfer image Z1 on the medium M2 is deteriorated.

On the other hand, in the example illustrated in FIG. 6B, the non-sublimation printing toner image CTI covers the unnecessary toner on the medium M1, which is transferred to the medium M1 by the “fogging”. Therefore, when the sublimation printing developer contained in the unnecessary toner on the medium M1 is sublimated in the iron-on transfer process, the sublimated printing developer is caught by the non-sublimation printing toner image CTI to dye the non-sublimation printing toner image CTI on the medium M1. As a result, it is possible to suppress the deterioration of the transferred image Z1 on the medium M2. Accordingly, when the medium M1 on which the sublimation printing toner image NTI and the non-sublimation printing toner image CTI are printed by the image formation apparatus 1 is used for executing the sublimation transfer, it is possible to manufacture clothes such as T-shirts or the like in which “fogging” is suppressed and which thus have a high image quality.

Here, if it is possible that the unnecessary toner is formed over the entire of the printing area α on the medium M1 except for the area of the sublimation printing toner image NTI, it is preferable that the non-sublimation printing toner image CTI is formed over the entire of the printing area α on the medium M1 except for the area of the sublimation printing toner image NTI. In this case, the non-sublimation printing toner CTI can cover all the unnecessary toner formed on the medium M1. Therefore, it is possible to reduce the possibility of failing to capture the sublimation printing developer that is sublimated from the unnecessary toner by the non-sublimation printing toner CTI. This can effectively suppress the deterioration of the print quality of the transferred image Z1 on the medium M2.

In an embodiment, the polymer compound contained in the non-sublimation printing toner CTI includes the polyester-based resin. In this case, it is possible to effectively catch the sublimation printing developer that is sublimated from the unnecessary toner by the high dyeability of the polyester-based resin. Therefore, it is possible to effectively suppress the deterioration of the print quality of the transferred image Z1 on the medium M2.

In an embodiment, the sublimation printing developer contained in the sublimation printing toner image NTI is a color toner and the non-sublimation printing developer contained in the non-sublimation printing toner image CTI is a clear toner. In this case, even if the non-sublimation printing toner image CTI is inadvertently attached to the medium M2, the deterioration of the print quality of the transferred image Z1 on the medium M2 can be suppressed owing to the transparency of the non-sublimation printing toner.

In an embodiment, the development parts 30N is disposed downstream of the development parts 30Y, 30M, 30C, and 30K. With this configuration, the non-sublimation printing toner CTI can cover the unnecessary toner on the medium M1 caused by the “fogging”. Therefore, it is possible to reduce the possibility of failing to capture the sublimation printing developer that is sublimated from the unnecessary toner by the non-sublimation printing toner CTI. This can effectively suppress the deterioration of the print quality of the transferred image Z1 on the medium M2.

In an embodiment, the print control signal to form the sublimation printing toner image NTI (first image) corresponding to the image data (first image data) input from the outside may be output to the development unit composed of the development parts 30Y, 30M, 30C, and 30K, while the print control signal to form the non-sublimation toner image CTI (second image) corresponding to an entire or a part of the background included in the image corresponding to the image data (first image data) input from the outside may be output to the development part 30N. In this case, the development unit composed of the development parts 30Y, 30M, 30C, and 30K forms the sublimation printing toner image NTI (first image) corresponding to the image data (first image data) input from the outside. Further, the development part 30N forms the non-sublimation toner image CTI (second image) corresponding to an entire or a part of the background included in the image corresponding to the image data (first image data) input from the outside. In this case, the user dose not need to separately prepare image data for forming the non-sublimation printing toner image CTI (second image) in addition to image data for forming the sublimation printing toner image NTI (first image). Accordingly, the transferred image Z1 with the high print quality can be obtained without additional work by the user.

### 2. Examples

Next, examples formed by the image formation apparatus 1 are described in comparison with a comparative example.

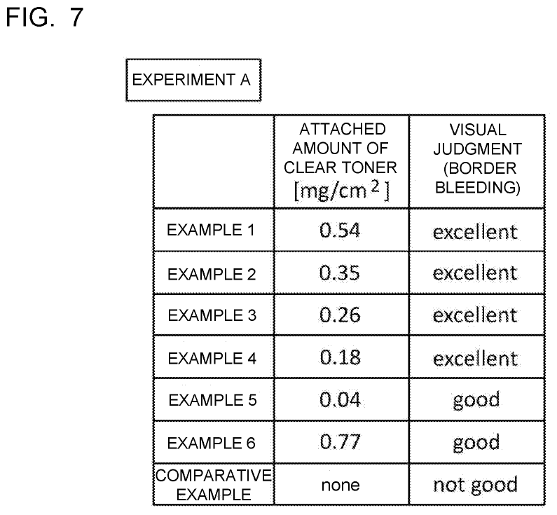

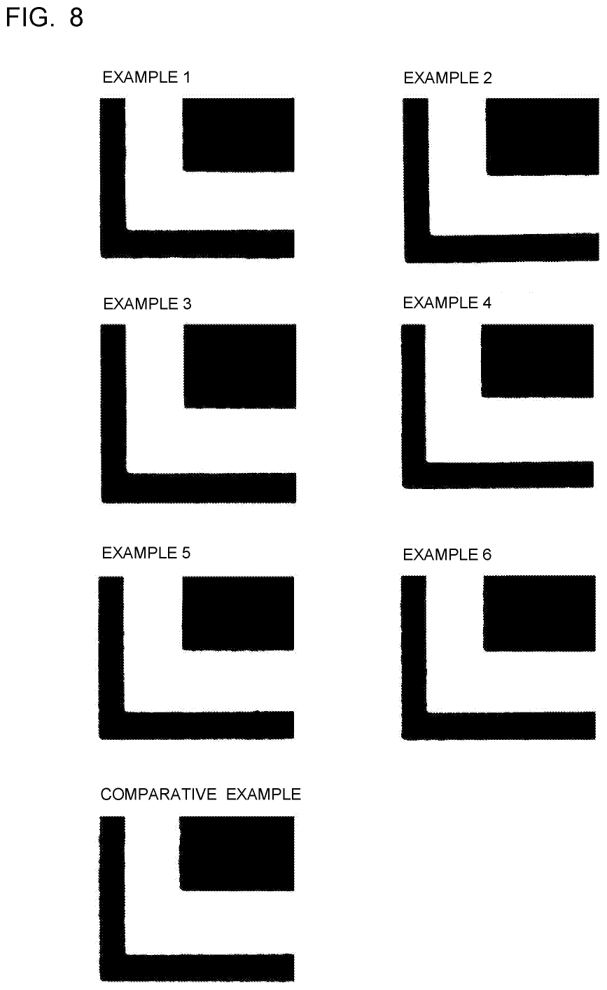

FIG. 7 illustrates the visual judgement results obtained by visually judging the degrees of the border bleeding on the medium M2 as changing the amount of the clear toner attached (formed) on the medium M1 (the results of Experiment A). FIG. 8 illustrates a part of the transferred image on the medium M2 of each example in Experiment A illustrated in FIG. 7. In Experiment A, a printer paper of A4 size (Excellent white, size: 297 mm×210 mm) available from Oki Data Corporation is used as the medium M1. In Examples 1 to 6, the print pattern illustrated in FIGS. 2A and 2B is printed. In Experiment A, a longitudinal feed of A4 size paper is performed at a printing speed of 137.1 mm/sec, which is equivalent to 30 PPM (Page Per Minute). In Experiment A, the clear toner and the sublimation printing toner are printed having the print pattern of the print image density of 100%.

Here, the print image density when a solid image is printed on the entire surface of a printable range having a predetermined area (for example, one rotation of the photosensitive drum or one page of the print medium) with an area ratio of 100% is called the print image density of 100%. That is, for example, the printing corresponding to an area of 1% with respect to the print image density of 100% is called the print image density of 1%.

Print image density={Cm(i)/(Cd×C0)}×100

Cm(i) is the number of dots actually used in printing (that is, the number of dots actually exposed in printing) while the photosensitive drum rotates Cd times.

C0 is the maximum number of dots used for a solid image per one rotation of the photosensitive drum. That is, Cd×C0 is the number of dots when the solid image is printed, that is, the maximum number of dots that can be printed while the photosensitive drum 111 rotates Cd times.

As the comparative example, the printed matters having the print pattern illustrated in FIGS. 2A and 2B without the clear toner are obtained. In Examples 1 to 6, the black sublimation printing toner is used as the sublimation printing toner and the development bias of the development part 30K is adjusted such that the density (OD value) of the sublimation printing toner printed on the medium M1 is 1.4. Note that when the density (OD value) of the image printed on the medium M1 is 1.4, the attached amount (formed amount) of the sublimation printing toner is 0.69 mg/cm². The densitometer X-Rite 528 available from X-Rite, Incorporated. is used as a density measurement device for measuring the density of the image on the medium M1. Further, the attached amount (formed amount) of the clear toner on the surface of the medium M1 is appropriately changed.

For measuring the image density of the printed matter, the measuring conditions in the measurement device “X-Rite 528” are set as follows. The measurement mode is set to “Density measurement mode”, the status is set to “Status I”, the white reference is set to “Absolute white reference”, and the polarizing filter is set to “No polarizing filter”. After calibrating with a white calibration plate, the image density is measured. Note that “Status I” is setting of the wavelength range to be evaluated, and specified in “ISO5-3: Photography and graphic technology-Density Measurements—Part 3: Spectral conditions.”

Note that the measurement of the image density of the sublimation printing toner and the attached amount (formed amount) of the clear toner on the medium M1 is executed as follows.

(1) The image formation apparatus 1 and the medium M1 are left standing in an environment (NN environment) having a temperature of 23° C. (Celsius) and a humidity of 50% RH for 24 hours.

(2) One sheet of white paper printing is performed every 30 seconds for 10 minutes, and the fixation section 50 is warmed up so as to heat the upper roller 51 and the lower roller 52 in the fixation section 50 to 155±5° C. and 135±5° C., respectively.

(3) The print pattern illustrated in FIGS. 2A and 2B is printed on one sheet of the medium M1 to obtain a printed matter.

(4) The printing is performed again under the same printing conditions as when the printing is performed in the procedure (3), and the printing is stopped before the print pattern is passed through the fixation section 50.

(5) The image density of the sublimation printing toner of the printed matter obtained in the procedure (3) is measured.

(6) The attached amount (formed amount) of the clear toner on the medium M1 on which the toner images (the print pattern) is formed in the procedure (4) is measured.

Note that the attached amount (formed amount) of the clear toner on the medium M1 is represented by the weight per 1 cm² (mg/cm²). In the procedure (6), the attached amount (formed amount) of the clear toner on the medium M1 is measured as follows.

A double-sided tape is attached to a flat surface area of a metal jig (in an area of 1 cm²), and a +300 V DC voltage is applied to the jig from an external power supply. Then, the jig is once pressed onto a predetermined area in the clear toner on the medium M1 having the print pattern (the toner images) transferred thereon, so as to collect the clear toner from the medium M1 to the jig. Then, the weight of the clear toner attached to the jig is measured with an electronic balance (Sartorius, CAP225D). Based on the difference in weight of the jig between before and after the collection of the toner, the attached amount (formed amount) of the clear toner on the medium per unit area (mg/cm²) is calculated. The procedures (2) to (6) described above are repeated three times, and an average value is obtained as the attached amount (formed amount) of the clear toner on the medium M1.

The printed matters obtained by the foregoing procedure are thermally transferred under the following conditions.

As the medium M2, an aluminum plate for sublimation transfer having a surface specially processed (ChromaLuxe available from PIOTEC co., Ltd., 5×7 inches, white gloss) is used to perform the thermal transfer. A heating press machine Model HTP234PS1 available from MagicTouch GmbH is used as an iron. The thermal transfer is performed under the conditions of a temperature of 190° C., a pressing time of 120 seconds, and a pressing pressure of 142 g/cm².

The transferred image made by the thermal transfer on the medium M2 is visually observed with a stereoscopic microscope SZX12 (available from OLMPUS corporation) at the observation magnification of 10 times to judge (evaluate) the border bleeding. The visual judgment criteria are as follows.

Excellent: Less border bleeding compared to the comparative example (no clear toner)

Good: Slightly less border bleeding compared to the comparative example (no clear toner)

Not Good: Border bleeding is about the same as in the comparative example (no clear toner)

As illustrated in FIGS. 7 and 8, when the clear toner is formed in an unprinted area of the sublimation printing toner (in the area outside the sublimation printing toner) on the medium M1 in such a manner that the attached amount (formed amount) of the clear toner on the medium M1 is not less than 0.04 mg/cm² and not more than 0.77 mg/cm², the judgement results are good or excellent and thus it is confirmed that the border bleeding is reduced. Since the clear toner layer is formed adjacent to the sublimation printing toner layer on the medium M1, the sublimation printing dye contained in the sublimation printing toner is caught by the clear toner upon the iron-on transfer, and thus the border bleeding can be reduced. It is considered that the clear toner layer provided adjacent to the sublimation printing toner layer prevents the peripheral edge of the sublimation printing toner from being deformed, and thus reduces the border bleeding. It is also considered that the clear toner layer formed adjacent to the sublimation printing toner layer on the medium M1 catches the sublimation printing dye sublimated from the peripheral edge of the sublimation printing toner pattern, and thus further reduces the border bleeding at the peripheral edge of the sublimation printing toner pattern upon the iron-on transfer.

Especially, when the attached amount (formed amount) of the clear toner on the medium M1 is not less than 0.18 mg/cm² and not more than 0.54 mg/cm², the judgement results are excellent. When the attached amount (formed amount) of the clear toner on the medium M1 is less than 0.18 mg/cm², the judgement results are good. It is considered that when the attached amount (formed amount) of the clear toner on the medium M1 is less than 0.18 mg/cm², the sublimated printing dye may not be sufficiently trapped by the clear toner and thus the border bleeding occurs at the boundary line. When the attached amount (formed amount) of the clear toner on the medium M1 is more than 0.54 mg/cm², the judgement results are good. It is considered that this is because, when the attached amount (formed amount) of the clear toner is too much, the clear toner may not be sufficiently fixed onto the medium 1 by the image formation apparatus 1, and thus the border bleeding occurs due to permeation of the vaporized pigment from voids in the clear toner layer during the iron-on transfer process.

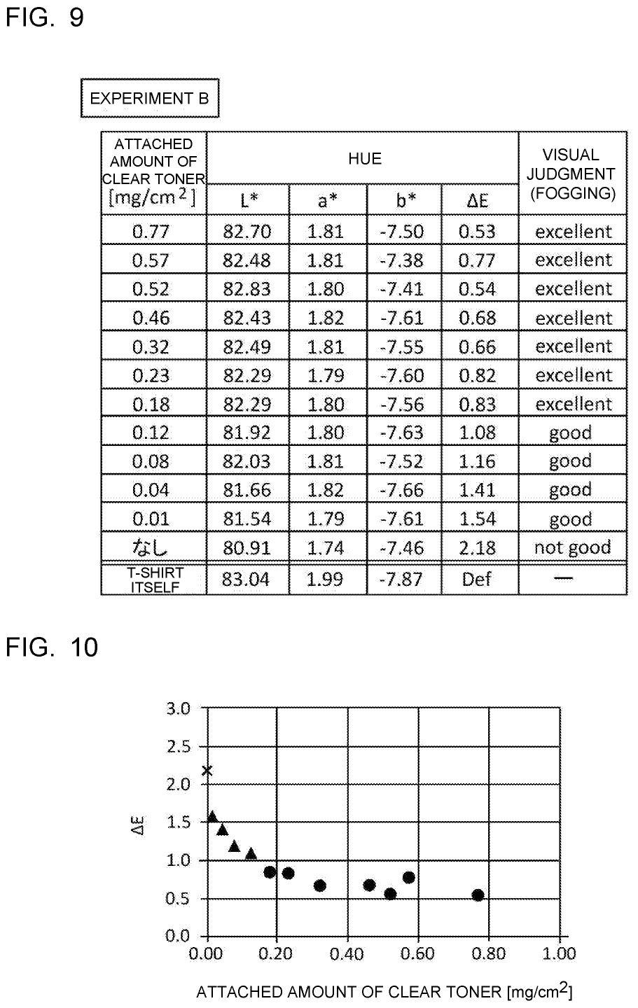

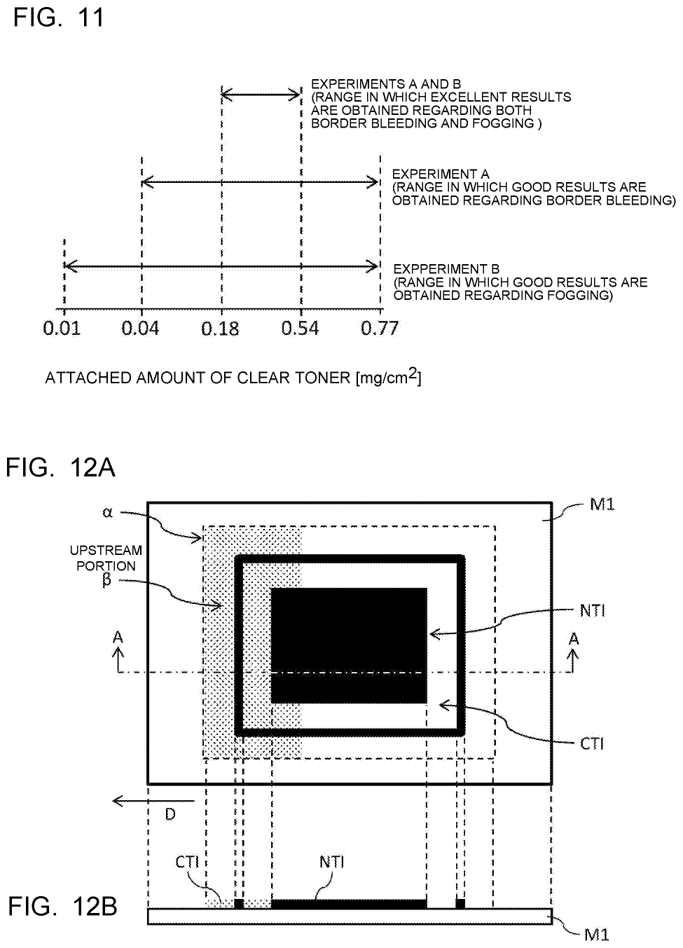

FIG. 9 illustrates the hue and the results (results of Experiment B) of the visual judgment of the degrees of “fogging” as changing the attached amount (formed amount) of the clear toner. FIG. 10 is a graph illustrating color difference ΔE in Experiment B illustrated in FIG. 9. FIG. 11 summarizes the results of Experiment A and Experiment B.

In Experiment B, a printer paper of A4 size (Excellent white, size: 297 mm×210 mm) available from Oki Data Corporation is used as the medium M1. In Experiment B, a print pattern of a clear toner having the print image density of 100% is printed. In Experiment B, the sublimation printing toners are not printed. However, the development parts 30Y, 30M, 30C, and 30K for the respective sublimation printing toners are provided (attached) in the image formation apparatus 1. Therefore, it is confirmed that the fogging toner is transferred to the medium M1. In Experiment B, the development bias of the development part 30K is adjusted such that the density (OD value) of the sublimation printing toner printed on the medium M1 is 1.4. In Experiment B, the attached amount (formed amount) of the clear toner on the medium M1 is different in each of the printed matters, like the case illustrated in FIG. 9.

The printed matters obtained by the foregoing procedure are thermally transferred under the following conditions. As the medium M2, a polyester material T-shirt (available from glimmer Co., Ltd.) is used for the thermal transfer. The thermal transfer is carried out under the conditions of a temperature of 200° C., a thermal transfer time of 1 minute, and a pressing pressure of 142 g/cm². The hue on the medium M2 after the thermal transfer is measured with the measurement device X-Rite 528 (available from X-Rite, Incorporated). The color difference ΔE is calculated from the following formula, based on the difference between the L* value, a* value, b* value of the medium M2 before the thermal transfer and the L* value, a* value, b* value of the medium M2 after the thermal transfer when the clear toner is provided. The color difference ΔE is calculated by the following formula:

ΔE═{(L*−L*Ref.)²+(a*−a*Ref.)²+(b*−*bRef.)²}^{1/2}

The hue on the medium M2 is measured with the measurement device X-Rite 528. Specifically, the measuring conditions of the measurement device X-Rite 528 are set as follows. The measurement mode is set to “L*a*b* color system measurement mode”, the status is set to “Status I”, the observation light source (illuminant) is set to “D50” (color temperature is about 5000K light source), the viewing angle (observation field of view) is set to “2 degree”, and the polarizing filter is set to “No polarizing filter”. After calibrating with a white calibration plate, the color difference is measured.

Note that the “L*a*b* color system” is a means that is useful for numerically expressing colors. The L* axis direction indicates lightness, the a* axis direction indicates the red-green hue, and the b* axis direction indicates the yellow-blue hue. The visual judgment criteria are as follows.

Excellent: Very little fogging on the medium M2

Good: A small amount of fogging on medium M2 by the visual judgment

Not Good: A large amount of fogging on the medium M2 by the visual judgment (conspicuous)

It is confirmed that because the clear toner layer is provided in an unprinted area of the sublimation printing toner, the fogging toner on the medium M1 is prevented from being sublimatively transferred onto the medium M2 in the iron-on transfer process. When the attached amount (formed amount) of the clear toner on the medium M1 is equal to or greater than 0.01 mg/cm², it is confirmed that the color difference (ΔE) is reduced to 1.54 or less, in comparison with the color difference (ΔE═2.18) of the comparative example having no clear toner. Especially, when the attached amount (formed amount) of the clear toner on the medium M1 is equal to or greater than 0.18 mg/cm², it is confirmed that the color difference (ΔE) is 1.83 and an extremely good effect of reducing the fogging is obtained.

When the colorant (dye) in the sublimation printing toner (the fogging toner) is sublimed and vaporized, the non-sublimation printing toner formed on the sublimation printing toner (the fogging toner) can physically guard the vaporized dye from reaching the medium M2. Further, since the clear toner is used as the non-sublimation printing toner is, the clear toner layer captures the sublimated colorant (sublimation printing developer) of the fogging toner and is dyed, and thus the medium M2 is not dyed. Thus, a further effect of reducing the sublimation printing (dying) on the medium M2 by the fogging toner or the like can be obtained.

To the contrary, when the attached amount (formed amount) of the clear toner on the medium M1 is less than 0.18 mg/cm², the thickness of the clear toner layer may be insufficient to prevent the medium M2 from being dyed by the fogging toner or the like. Therefore, it is considered that a sufficient effect may be not obtained even though the fogging is reduced.

In Experiment B, the controller 70 may analyze the print pattern of the sublimation printing toner and control forming the clear toner layer in the unprinted area of the print pattern of the sublimation printing toner, or the user may create in advance the print pattern of the sublimation printing toner and the print pattern of the clear toner by an external device (for example, a personal computer, or the like)

Note that Experiment B is executed under the environment (NN environment) having the temperature of 23° C. and the humidity of 50% RH. However, it may be executed only under the environment (HH environment) having the temperature of 27° C. and the humidity of 80% RH. Further, it may be appropriately executed only in an area in the vicinity of a toner low portion where the fogging is worse due to the deterioration of the toner, only when the image forming apparatus 1 detects that the surrounding environment is an environment where the fogging is to become worse, or only for a first paper sheet after the printing is started where the fogging is to become worse.

### <Modifications>

Next, modifications of the image formation apparatus 1 according to above-described one or more embodiments are described.

### [Modification A]

In one or more embodiments described above, the unnecessary toner (fogging toner) formed in the area outside the area of the sublimation printing toner image NTI may be formed selectively at an upstream portion in the conveyance direction D in the printing area α of the medium M1. In this case, the development part 30N may selectively form the non-sublimation printing toner image CTI (second image) at an upstream portion (upstream area β) in the printing area α of the medium M1 in the positional relationship with the sublimation printing toner image NTI (first image) in the conveyance direction D. In this case, the non-sublimation printing toner CTI can intensively cover the unnecessary toner formed on the medium M1. Therefore, it is possible to reduce the possibility of failing to capture the sublimation printing developer that is to be sublimated from the unnecessary toner by the non-sublimation printing toner CTI. This can effectively suppress the deterioration of the print quality of the transferred image Z1 on the medium M2.

### [Modification B]

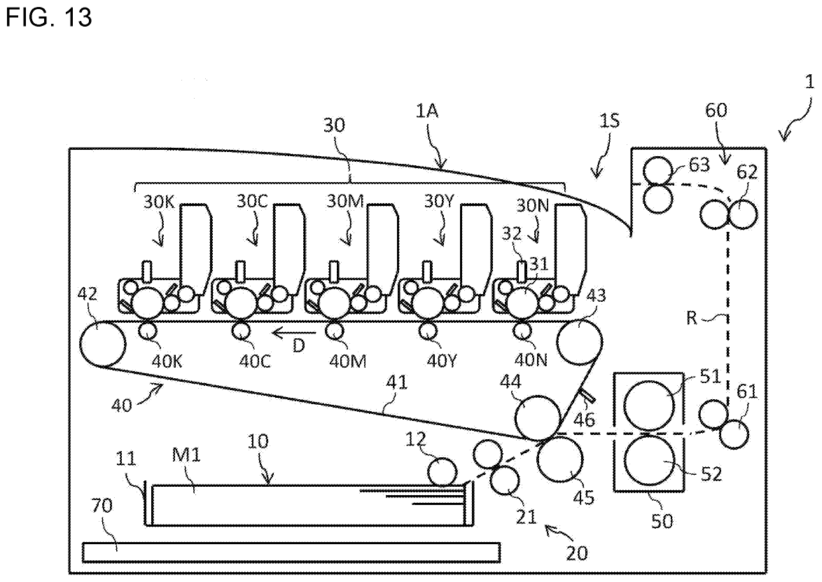

In one or more embodiments and modifications described above, the image formation apparatus 1 is the direct-transfer type printer that forms the image directly on the medium M1 to be discharged to the outside. However, the image formation apparatus 1 may be an intermediate transfer type printer that forms the image on the medium M1 by using an intermediate transfer belt 41, such as being illustrated in FIG. 13. In this modification B, the development parts 30N, 30Y, 30M, 30C, and 30K are disposed in this order from the upstream side toward the downstream side in the conveyance direction D of the intermediate transfer belt 41, for example. That is, the development part 30N is disposed upstream of the development parts 30Y, 30M, 30C, and 30K in the conveyance direction D of the intermediate transfer belt 41.

In this modification B, the transfer section 40 includes five transfer rollers 40y, 40M, 40C, 40K, and 40N, the intermediate transfer belt 41, a drive roller 42, a driven roller 43, a backup roller 44, a secondary transfer roller 45, and a cleaning blade 46, for example. The intermediate transfer belt 41 in this modification B may be an example of an “intermediate transfer medium” of the disclosure. The drive roller 42, the driven roller 43, and the backup roller 44 in this modification B may be an example of a “first conveyance section” of the disclosure. The transfer rollers 40y, 40M, 40C, 40K, and 40N in this modification B may be an example of a “first transfer section” of the disclosure. The secondary transfer roller 45 in this modification B may be an example of a “second transfer section” of the disclosure. The discharge section 60 in this modification B may be an example of a “discharge section” of the disclosure.

The intermediate transfer belt 41 is a medium to which the toner is temporarily transferred before the toner is transferred to the medium M1, and is, for example, an endless elastic belt. The medium M1 may be an example of a “medium” or a “medium” (sheet medium) that is to be discharged to an outside of an image formation apparatus in the disclosure. The intermediate transfer belt 41 includes one type or two or more types of polymer materials such as polyimide or the like, for example. The intermediate transfer belt 41 is movable in accordance with the rotation of the drive roller 42 in a state of being stretched by the drive roller 42, the driven roller 43, and the backup roller 44, for example.

The drive roller 42 is controlled by the controller 70 to be rotated to convey the intermediate transfer belt 41 in a direction from the development part 30N side toward the development part 30K side. Each of the driven roller 43 and the backup roller 44 is rotatable according to the rotation of the drive roller 42, for example. The drive roller 42, the driven roller 43 and the backup roller 44 conveys the intermediate transfer belt 41. The five transfer rollers 40Y, 40M, 40C, 40K, and 40N transfer (primarily transfer) the toners attached to the electrostatic latent images to the intermediate transfer belt 41. A transfer roller module composed of four transfer rollers 40Y, 40M, 40C, and 40K transfers the sublimation printing toners onto the intermediate transfer belt 41 to form the sublimation printing toner image NTI on the intermediate transfer belt 41. The transfer roller 40N transfers the non-sublimation printing toner onto the intermediate transfer belt 41 to form the non-sublimation printing toner image CTI on the intermediate transfer belt 41. The five transfer rollers 40Y, 40M, 40C, 40K, and 40N are pressed against the photosensitive drums 30 of the development parts 30Y, 30M, 30C, 30K, and 30N, respectively, with the intermediate transfer belt 41 therebetween. The development part 30N may form the non-sublimation printing toner image CTI selectively at an upstream portion on the intermediate transfer belt 41 in the positional relationship with respect to the sublimation printing toner image NTI in the conveyance direction (in the direction from the development part 30N side toward the development part 30K side) of the intermediate transfer belt 41.

The secondary transfer roller 45 transfers (secondarily transfers) the toners (the sublimation printing toner image NTI and the non-sublimation printing toner image CTI) transferred to the intermediate transfer belt 41 to the medium M1. The secondary transfer roller 45 is in pressure contact with the backup roller 44, and includes, for example, a metal core material and an elastic layer such as a foam rubber layer that covers the outer peripheral surface of the core material. The drive roller 42 is controlled by the controller 70 to be rotated in a rotational direction to convey the intermediate transfer belt 41 in the direction from the development part 30N side toward the development part 30K side. The cleaning blade 46 is pressed against the intermediate transfer belt 41 and scrapes off foreign matter and residual toner remaining after the secondary transfer on the surface of the intermediate transfer belt 41. The discharge section 60 discharges the medium M1 having the sublimation printing toner image NTI and the non-sublimation printing toner CTI transferred (printed) thereon to the outside of the image formation apparatus 1.

As described above, the image formation apparatus 1 in the modification B is the intermediate transfer type printer. In this modification, effects same as or similar to those of one or more embodiments or modifications described above can be obtained. Further, in this modification B, the development parts 30N is disposed upstream of the development parts 30Y, 30M, 30C, and 30K in the running direction D of the intermediate transfer belt 41. With this configuration, the non-sublimation printing toner CTI can cover the unnecessary toner on the medium M1, which is caused by the “fogging”. Therefore, it is possible to reduce the possibility of failing to capture the sublimation printing developer that is sublimated from the unnecessary toner by the non-sublimation printing toner CTI. This can effectively suppress the deterioration of the print quality of the transferred image Z1 on the medium M2.

### [Modification C]

In one or more embodiments or modifications described above, the image formation apparatus 1 is the electrophotographic full-color printer. However, in one or more embodiments or modifications described above, the image formation apparatus 1 may be an inkjet printer or an inkjet full-color printer. In this case, inks are used instead of the toners. Specifically, sublimation printing inks are used instead of the sublimation printing toners. The sublimation printing ink is color ink that is, when heated, to be transferred to the medium M2 due to its sublimation transferability. A non-sublimation printing ink is used instead of the non-sublimation printing toner. The non-sublimation printing ink is, for example, a clear ink. Even in this case, effects same as or similar to those of one or more embodiments or modifications described above can be obtained.

### [Modification D]

In one or more embodiments or modifications described above, the image formation apparatus 1 is the printer. However, the image forming apparatus 1 is not limited to a printer, and may be a copying machine, a facsimile machine, a multi-functional apparatus having these functions, or the like. Even in this case, effects same as or similar to those of one or more embodiments or modifications described above can be obtained.

### [Modification E]

In one or more embodiments or modifications described above, the series of processes may be executed by a hardware (circuitry) or a software (programs). In the case where the series of processes is executed by a software, the software is composed of a group of programs to be executed by a computer to perform each function. Each of the programs may be installed in the computer in advance, or may be installed in the computer from a network or a recording medium, or the like.

The invention includes other embodiments or modifications in addition to the above-described embodiments and modifications without departing from the spirit of the invention. The embodiments and modifications described above are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An image formation apparatus comprising: a first image formation unit configured to develop a first image on a medium by using a sublimation printing developer; and a second image formation unit configured to develop a second image by using a non-sublimation printing developer in an area outside an area of the first image on the medium.

2. The image formation apparatus according to claim 1, wherein the sublimation printing developer includes a colorant whose sublimability is higher than that of the non-sublimation printing developer, and the non-sublimation printing developer is formed of a material whose sublimability is lower than the colorant of the sublimation printing developer.

3. The image formation apparatus according to claim 2, wherein the non-sublimation printing developer is a dyeable developer containing polymer compound that can be dyed with the colorant.

4. The image formation apparatus according to claim 3, wherein the polymer compound includes a polyester-based resin.

5. The image formation apparatus according to claim 1, wherein the sublimation printing developer comprises a color toner or a color ink and the non-sublimation printing developer comprises a clear toner or a clear ink.

6. The image formation apparatus according to claim 1, wherein the second image formation unit is configured to develop the second image adjacent to the first image.

7. The image formation apparatus according to claim 1, wherein the second image formation unit is configured to develop the second image in an entire of a printing area on the medium except for the area where the first image is developed.

8. The image formation apparatus according to claim 1, further comprising a conveyance section that conveys the medium, wherein the medium is a sheet medium.

9. The image formation apparatus according to claim 8, wherein the second image formation unit is provided downstream of the first image formation unit in a conveyance direction in which the medium is conveyed by the conveyance section.

10. The image formation apparatus according to claim 9, wherein the second image formation unit selectively develops the second image at a position upstream of the first image on the medium in a conveyance direction of the medium.

11. The image formation apparatus according to claim 1, wherein the medium is an intermediate transfer medium, and the image formation apparatus includes a first conveyance section that conveys the intermediate transfer medium, a first transfer section that transfers the first image and the second image to the intermediate transfer medium, and a second transfer section that transfers the first image and the second image from the intermediate transfer medium to a sheet medium that is to be discharged to the outside of the image formation apparatus.

12. The image formation apparatus according to claim 11, wherein the second image formation unit is provided upstream of the first image formation unit in a conveyance direction of the intermediate transfer medium by the first conveyance section.

13. The image formation apparatus according to claim 12, wherein the second image formation unit selectively develops the second image at a position upstream of the first image on the intermediate transfer medium in the conveyance direction of the intermediate transfer medium.

14. The image formation apparatus according to claim 1, wherein the first image formation unit develops, as the first image, an image corresponding to image data input from the outside, and the second image formation unit develops, as the second image, a part of or an entire of a background contained in the image corresponding to the image data.

15. The image formation apparatus according to claim 1, wherein the second image formation unit develops the second image on the medium with an attached amount of the second image on the medium being equal to or greater than 0.01 mg/cm².

16. The image formation apparatus according to claim 1, wherein the second image formation unit develops the second image on the medium with an attached amount of the second image on the medium being equal to or greater than 0.04 mg/cm².

17. The image formation apparatus according to claim 1, wherein the second image formation unit develops the second image on the medium with an attached amount of the second image on the medium being equal to or greater than 0.18 mg/cm².

18. The image formation apparatus according to claim 1, wherein the second image formation unit develops the second image on the medium with an attached amount of the second image on the medium being equal to or less than 0.77 mg/cm².

19. The image formation apparatus according to claim 1, wherein the second image formation unit develops the second image on the medium with an attached amount of the second image on the medium is equal to or less than 0.54 mg/cm².

20. An image formation method comprising: developing a first image on a medium by using a sublimation printing developer; and developing a second image by using a non-sublimation printing developer in an area outside an area of the first image on the medium.
